(19) United States
(12) Patent Application Publication
(10) Pub. No.: US 2009/0072014 A1
(43) Pub. Date: Mar. 19, 2009

(54) COMPOSTABLE PACKAGING, METHODS AND APPARATUS FOR MANUFACTURING SAME

(75) Inventor: Robert Von Felden, Concord, CA (US)

Correspondence Address: PERKINS COIE LLP, P.O. BOX 1208, SEATTLE, WA, 98111-1208, US

(73) Assignee: Eco-Fiber Solutions, Inc.

(21) Appl. No.: 12/233,531

(22) Filed: Sep. 18, 2008

Related U.S. Application Data
(60) Provisional application No. 60/973,433, filed on Sep. 18, 2007.

(51) Int. Cl. B65D 5/42; B31F 1/28

(52) U.S. Cl. 229/5.81; 162/136; 156/207; 118/75

(57) ABSTRACT

A system and method for producing waterproof corrugated boards and containers. A technique for waterproofing paper coats the paper with resin, uses non-wicking medium, and creates waterproofed corrugated boards using an adhesive that is compatible relative to the resin used to make the medium non-wicking. The adhesive should also be water resistant or waterproof. Containers made with waterproofed corrugated boards withstand being exposed to wet contents.

### CLAIM OF PRIORITY

This application claims priority to U.S. Provisional Patent Application No. 60/973,433 entitled “Compostable Packaging, Methods And Apparatus For Manufacturing Same”, which was filed on Sep. 18, 2007 by Robert Von Felden, the contents of which are expressly incorporated by reference herein.

### BACKGROUND

The foregoing examples of the related art and limitations related therewith are intended to be illustrative and not exclusive. Other limitations of the related art will become apparent to those of skill in the art upon a reading of the specification and a study of the drawings.

During the paper making process, cellulose fibers are mixed in with water to make slurry. A headbox deposits the slurry evenly onto a moving wire screen, where water drains from the slurry, forming a paper mat. This part of the paper making process is called the wet-end. The paper mat is then passed through a series of presses and dryers in order to obtain a web-continuous roll of paper.

The paper produced in the paper making process may be paperboard. Corrugated board is constructed by combining two different kinds of container boards; the linerboard (flat paperboard) and the medium (center fluted paperboard).

The corrugator puts the flutes in the medium and a flute adhesive is used to adhere the linerboard and medium together. The adhesive used in this process is prepared in an adhesive preparation system, and the adhesive is typically made of water and corn, potato, wheat or any other vegetable based starch mixed with other chemicals. A single face corrugated board is produced when the medium is attached to only one linerboard; this first-applied linerboard is called the “singleface”. When a second linerboard is attached to the other side of the medium, it is called the “doubleback” or “doubleface” surface.

A cutter is used to convert the continuous corrugated board produced by the corrugator into container blanks, which then have to be cut, scored, and slotted. The cutter for this final step may be a die cutter, a printer-slotter, or a flexo folder-gluer.

The container board may be printed on at any stage during the container making process, but the printing is usually done on the container blank.

A corrugated container may be obtained by gluing the joints of the container blank together.

Providing recyclable waterproofed containers has not been accomplished. Approaches such as Styrofoam® are not recyclable. Wax coated (Cascaded and Curtain) corrugated material is not considered by the paper industry to be recyclable but is very resistant to water. What is needed is a container that is recyclable but is not destroyed by water.

### SUMMARY

The following embodiments and aspects thereof are described and illustrated in conjunction with systems, tools, and methods that are meant to be exemplary and illustrative, not limiting in scope. In various embodiments, one or more of the above described problems have been reduced or eliminated, while other embodiments are directed to other improvements.

A technique for waterproofing paper coats the paper with resin, uses non-wicking medium, and creates waterproofed corrugated boards using an adhesive that is compatible relative to the resin used to make the medium non-wicking. The adhesive must also be water resistant or waterproof. Advantageously, containers made with waterproofed corrugated boards withstand being exposed to wet contents, when untreated corrugated boards would become waterlogged and fail structurally.

A method based on the technique applies resin to paper, and forms the paper into corrugated board. The corrugated board can be cut into container blanks, which are then formed into containers. Glue may be used to glue the joints of the container blank to form a container, where the glue is compatible relative to the resin used to waterproof the paper. The glue used to construct containers must be waterproof.

A system for making printed waterproof containers out of paper may include some of the following: a coater, a dryer, a printer, a corrugation device, and a cutter. The cutter may be a die cutter or any other means for cutting the paper board into blanks. The paper may be waterproofed, formed into corrugated board, and constructed into containers.

### BRIEF DESCRIPTION OF THE DRAWINGS

FIG. 1 depicts a diagram 100 of a system for creating a waterproofed environmentally friendly paper container.

FIG. 2 depicts a flowchart 200 of a method for creating a waterproofed environmentally friendly paper container.

FIG. 3 depicts a diagram 300 of an environmentally friendly paper container.

FIG. 4 depicts a flowchart 400 of a method for creating a waterproofed environmentally friendly web-continuous coated rolls of paper.

FIG. 5 depicts a flowchart 500 of a method for creating a waterproofed environmentally friendly corrugated-board.

FIG. 6 depicts a flowchart 600 of a method for creating a waterproofed environmentally friendly paper container.

FIG. 7 depicts a diagram of an example of a process for creating a container.

FIG. 8 depicts a diagram of an example of a process for creating paper.

FIG. 9 depicts a diagram of an example of a cross section of a waterproof corrugated board.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various teachings disclosed herein.

A variety of waterproof containers may be desirable. Generally, food product containers should not be reused to avoid introducing contamination into fresh food. For example, fish are wet and are often packed in ice that melts, thereby soaking paper containers. Fish containers must be disposed because fresh fish may not be stored in old fish containers. Advantageously, recyclable paper containers may be used only once and then recycled into a new container.

A wet-end treatment may increase the water-resisting and non-wicking properties of paper. A water-blocking resin such as a water-based polymer may be introduced at the wet-end during the paper making process, along with other wet-end chemistry. In a non-limiting example, the water based polymer may be a modified polyester dispersion, such as, for example, NVS 300WE. This resin may be introduced to the slurry or at the headbox and will bond to the fiber during the paper making process, thereby introducing non-wicking characteristics to the paper.

A web-continuous roll of paper may be produced with or without wet-end treatment. The paper may be topically coated with a water-based polymer resin such as, in a non-limiting example, NVS 500, or any other formulated pigment/binder applied as a basecoat. The resin is cured using a dryer, such as an IR dryer and/or a forced air dryer. A second topical coating (topcoat) of a resin, such as a modified polymer dispersion, is then applied to the paper and provides water resistance, while enabling repulpability of the paper. In a non-limiting example, the second topical coating is NVS 250. The paper quality along with the application approach and other variables during paper production (such as conveying speed of the roll) will determine the appropriate coat weight to achieve a desired end product.

If the topcoat (e.g.: NVS 250) is applied after the basecoat (e.g.: NVS 500) has been cured, the paper may be subjected to another dryer to cure the topcoat. Alternatively, the topcoat may be applied after the application of the basecoat, but before the drying process, and the paper with both coatings is then subjected to a dryer to cure both resins. The process where both coatings are dried and cured at the same time is less efficient, typically requiring the use of more of the topcoat. Both coatings may be applied using traditional coating methods, such as rod, blade, air knife, roll coater and others.

The topcoat may also be applied without first applying the basecoat. However, this may require the use of more of the topcoat, which is typically more expensive than the basecoat.

A corrugator is used to form a center-fluted medium and glue the medium to a first flat linerboard (the singleface) and then in series, to a second flat linerboard (the doubleback or doubleface). The medium may be made from paper that underwent a wet-end treatment with a water-blocking resin as described previously. One or both of the flat linerboards are coated with one or more coatings of a resin to provide water resistance, as described above. The medium and flat linerboard may be adhered together to form corrugated board using a water resistant adhesive that will not interact with the medium to preserve the water resistant characteristics of medium treated with resin. The adhesive may contain generic carrier starch. As will be appreciated by those skilled in the art, a wide variety of suitable adhesives are commercially available. For example, an adhesive resin with urea in a water solution, such as Eco-Res I manufactured by the NVS Group, together with a generic carrier starch can work.

The adhesive may be prepared in a starch kitchen. Operating conditions of the specific application will define the precise ratios of the chemistry. For example, a starting point for a resin addition to starch to obtain a waterproof adhesive may be a weight amount of resin equal to 6% of the total weight of starch. To obtain a water resistant adhesive, a weight amount of resin equal to 4% of the total weight of starch may be added to the starch. For a moisture vapor resistant adhesive, an addition of weight amount of resin equal to 2% of the total weight amount of starch is needed. The paper should be at least 35 degrees Fahrenheit above the starch gelatinization temperature (typically around 180 degrees Fahrenheit, depending on the type of starch used) to bond with the adhesive. If the paper is too hot (typically above 220 degrees Fahrenheit, depending on the starch), the starch will crystallize, causing zipper board. Liner temperatures should be measured at least once per full roll across the web to ensure optimal temperature of the paper (typically between 180-220 degrees Fahrenheit). A temperature of between 140-150 degrees Fahrenheit may be needed for the water-resistant adhesive to reach the gel point, in order for it to adhere to the paper.

A sheeter/converter produces blanks from the corrugated board, where the blanks are cut, scored, and slotted. The blanks may then be converted into waterproof containers or other forms by folding the blank along the scores to form the container and then applying glue or using other means to hold the joints of the blank together to form a container. To provide a waterproof container, the glue must be waterproof.

Some examples of waterproof containers include a cooler, a poultry box, a fish box, a produce tray, a food processor tray, a floral tray, or a collapsible crate. Such containers may regularly come into contact with water, or wet products.

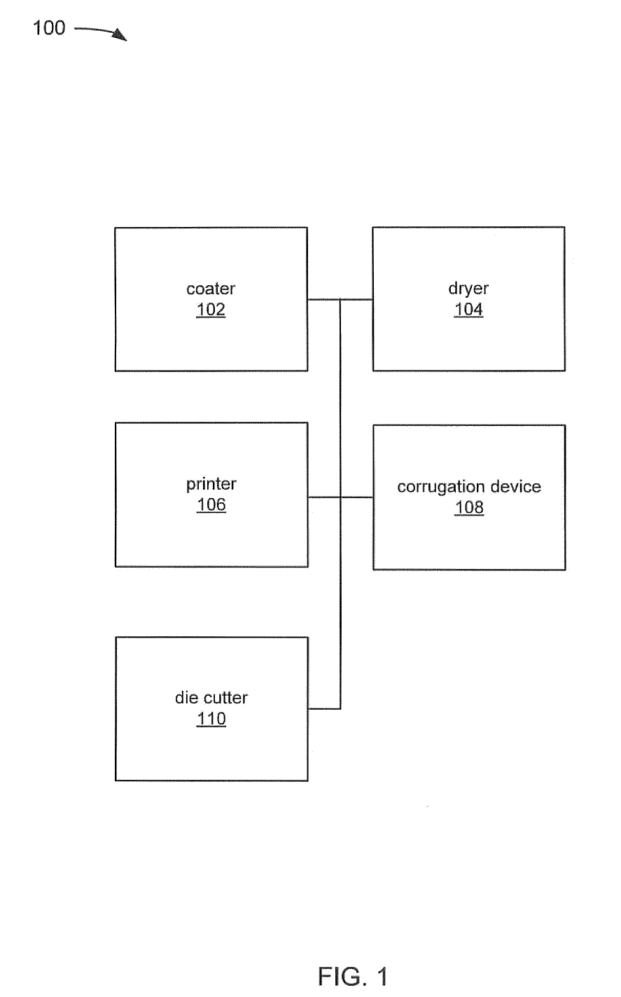

FIG. 1 depicts a diagram 100 of a system for creating waterproofed environmentally friendly paper containers. FIG. 1 includes coater 102, dryer 104, printer 106, corrugation device 108, and die cutter 110.

Coater 102 may accept a web-continuous roll of paper and apply a resin to paper. The paper may be recycled or virgin paper. Resin may be included in the paper itself when the paper is prepared.

Resin generally resists water and may be impervious to it. Resin used in this process may include one or more of the following components in various proportions: NVS 250 and NVS 500.

The dryer 104 may be an infrared (IR) dryer or a forced air dryer, or any other dryer that is readily available or convenient. The resin may be cured at one or more temperatures. For Example, the temperature may be set at 205 degrees Fahrenheit; it may be higher or lower though it is important that the resin is completely cured.

Printer 106 prints patterns, words, images, or other graphical matter on paper treated with the resin. Ink used by the printer should be a low impact and/or compatible with the water-proof resin so as to permanently imprint a design or words on a container. Advantageously, the ink is able to print on the paper where water based products may not. The ink may or may not be waterproof itself. The ink may be applied to the paper before or after the paper has been corrugated though typically it is applied after corrugation during or subsequent to the form cutting process.

Corrugation device 108 accepts paper treated with resin and forms it into corrugated board. Corrugation device 108 applies adhesive to one or more pieces of paper that are fluted and attaches one or more flat sheets of paper treated with resin to the fluted sheet to form a sheet of corrugated board.

Die cutter 110 receives a sheet of corrugated board and using, for example, a pre-cut die, cuts a container shape out of the sheet. The container shape may contain cuts which when used to erect the container provide a structure to the container.

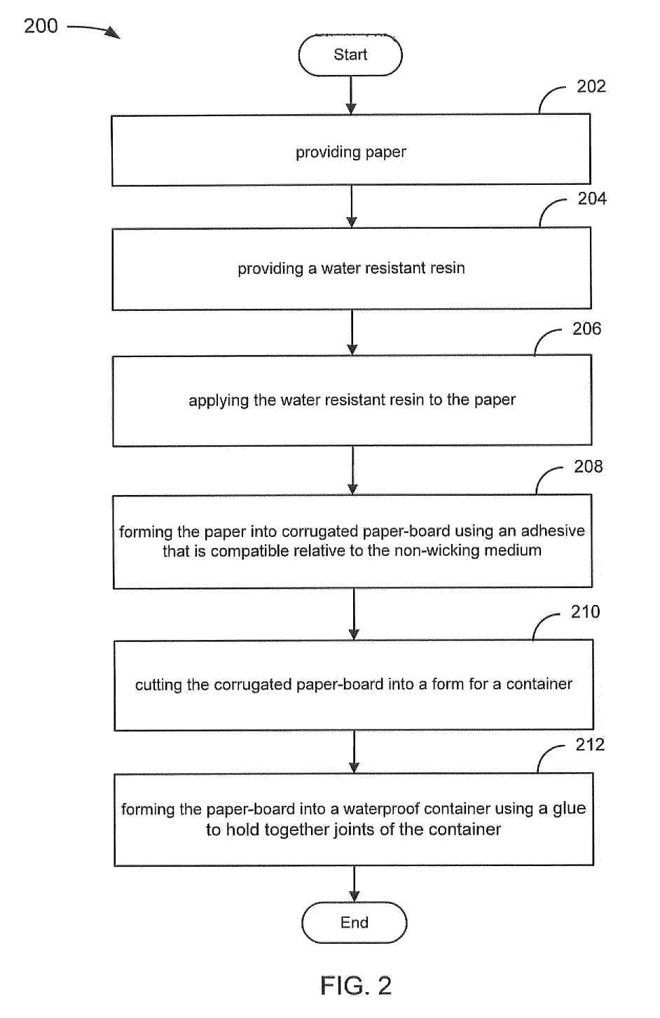

FIG. 2 depicts a flowchart 200 of a method for creating a waterproofed environmentally friendly paper container. The method is organized as a sequence of modules in the flowchart 200. However, it should be understood that these and modules associated with other methods described herein may be reordered for parallel execution or into different sequences of modules.

In the example of FIG. 2, the flowchart 200 starts at module 202 with providing paper. The paper may be recycled paper or virgin paper. The paper may be a sheet of paper coated with a resin causing it to be impervious to water. The paper may include resin incorporated in the wet end when the paper is being made.

In the example of FIG. 2, the flowchart 200 continues to module 204 with providing a water resistant resin. The resin may be resin as defined in reference to FIG. 1.

In the example of FIG. 2, the flowchart continues to module 206 with applying the water resistant resin to the paper. Paper may be coated with resin by spraying, rolling or any other means for evenly spreading the resin over the paper.

In the example of FIG. 2, the flowchart continues to module 208 with forming the paper into corrugated paper-board using an adhesive that is compatible relative to the non-wicking medium.

In the example of FIG. 2, the flowchart continues to module 210 with cutting the corrugated paper-board into a form for a container. A die cutter may be used. The die cutter may have a pre-determined form on a drum that rolls over a sheet of paper-board cutting the paper-board. The cutting may be accomplished by any means convenient or readily available.

In the example of FIG. 2, the flowchart continues to module 212 with forming the paper-board into a waterproof container using a glue to hold together joints of the container. The glue does not need to but may be the same as the adhesive used to form the corrugated board. Having created an environmentally friendly paper container, the flowchart terminates.

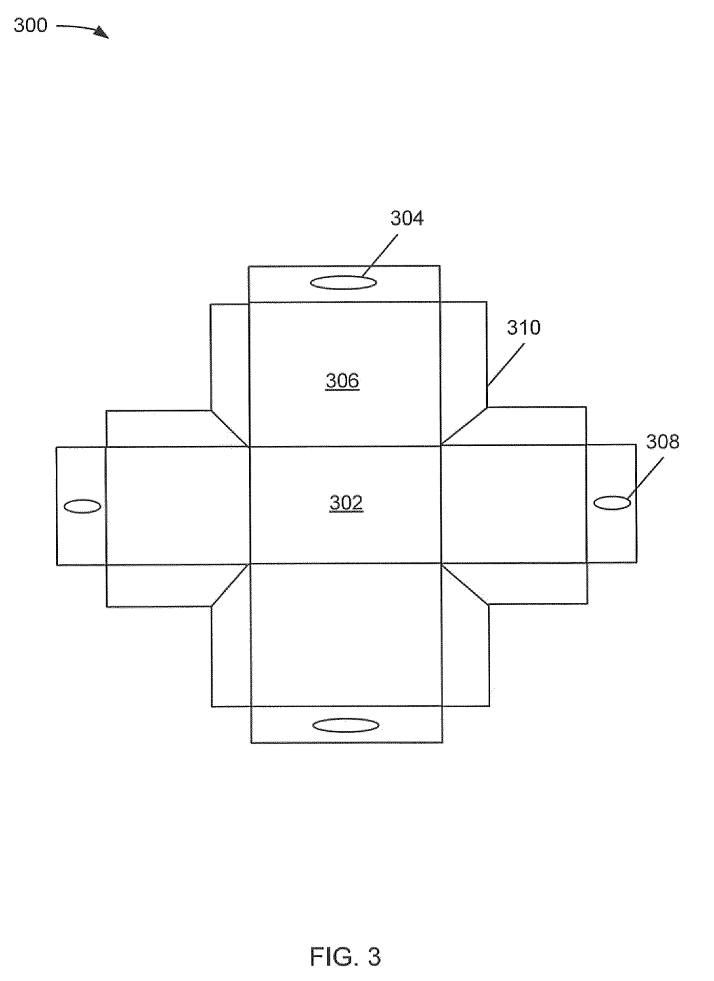

FIG. 3 depicts a diagram 300 of an environmentally friendly paper container. Diagram 300 includes base 302, handle 304, wall 306, cut 308, and flap 310. Diagram 300 depicts a single sheet of paper-board. Lines drawn may be folds in the paper-board or may indicate holes in the paper-board.

Base 302 is the bottom of a container. Wall 306 is one of four walls that will stand perpendicular to base 302. Flap 310 when folded and connected to wall 306 via adhesive provides structure for the container. Cut 308 may be useful for securing folded parts of the container with adhesive. When assembled, the container will have handle 304 above base 302 for a user to hold in carrying the container.

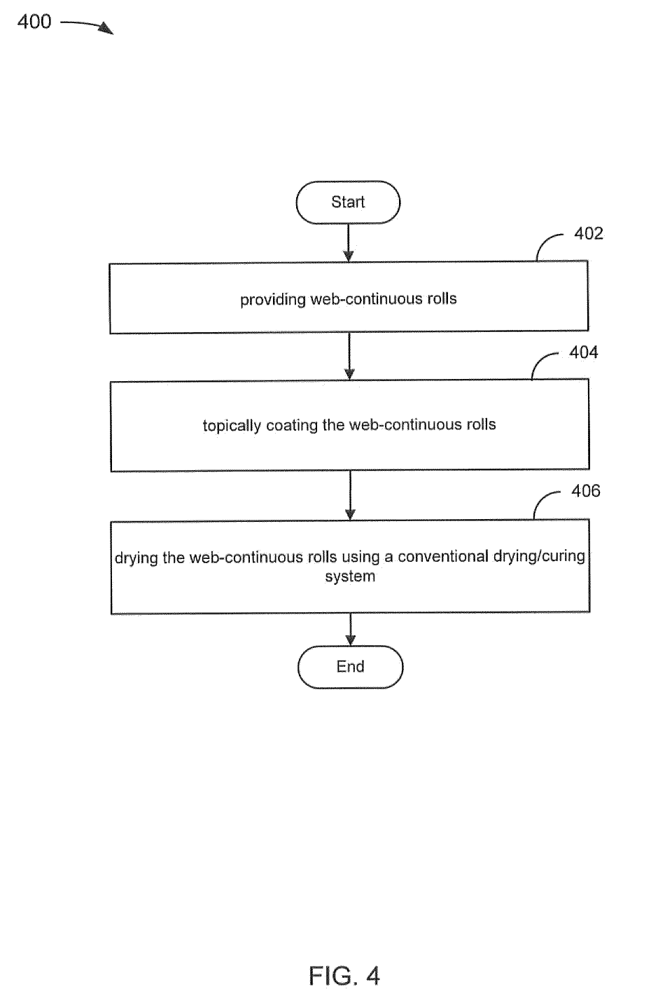

FIG. 4 depicts a flowchart 400 of a method for creating a waterproofed environmentally friendly paper container. The method is organized as a sequence of modules in the flowchart 400. However, it should be understood that these and modules associated with other methods described herein may be reordered for parallel execution or into different sequences of modules.

In the example of FIG. 4, the flowchart 400 starts at module 402 with providing web-continuous rolls. A web-continuous roll may include a continuous sheet of paper that may or may not include resin.

In the example of FIG. 4, the flowchart 400 continues to at module 404 with topically coating the web-continuous rolls.

In the example of FIG. 4, the flowchart 400 continues to module 406 with drying the web-continuous rolls using a conventional dryer/curing system, such as an infrared (IR) dryer or other types of dryers mentioned previously. In a non-limiting example, the infrared dryer may be configured to achieve a temperature of 205 degrees Fahrenheit at the paper surface.

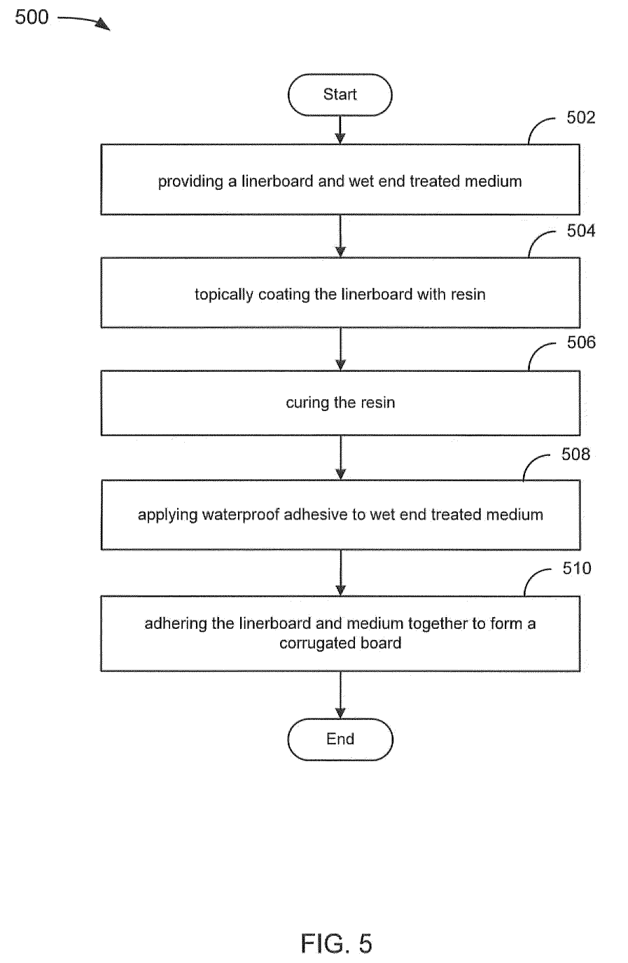

FIG. 5 depicts a flowchart 500 of a method for creating a waterproofed environmentally friendly corrugated board. The method is organized as a sequence of modules in the flowchart 500. However, it should be understood that these and modules associated with other methods described herein may be reordered for parallel execution or into different sequences of modules.

In the example of FIG. 5, the flowchart 500 starts at module 502 with providing a linerboard and medium. The medium is a center fluted paper board and may or may not have been treated with a resin at the wet-end to provide non-wicking characteristics.

In the example of FIG. 5, the flowchart 500 continues to module 504 with topically coating the linerboard with a resin as discussed in reference to FIG. 1. One or more coatings of resin may be applied to the paper.

In the example of FIG. 5, the flowchart 500 continues to module 506 with curing the resin. The curing may be done by using a dryer such as an IR dryer or any method of drying.

In the example of FIG. 5, the flowchart 500 continues to module 508 with applying a waterproof adhesive to wet-end treated medium. The adhesive is typically applied in a corrugator. The adhesive may be applied to the linerboard or the medium or it may be applied to both.

In the example of FIG. 5, the flowchart 500 continues to module 510 with adhering the linerboard and medium together. The linerboard should be applied to one side of the medium. A second linerboard may be applied to the other side of the medium. Corrugation may be accomplished as discussed in reference to FIG. 1. Having created environmentally friendly corrugated board, the flowchart terminates.

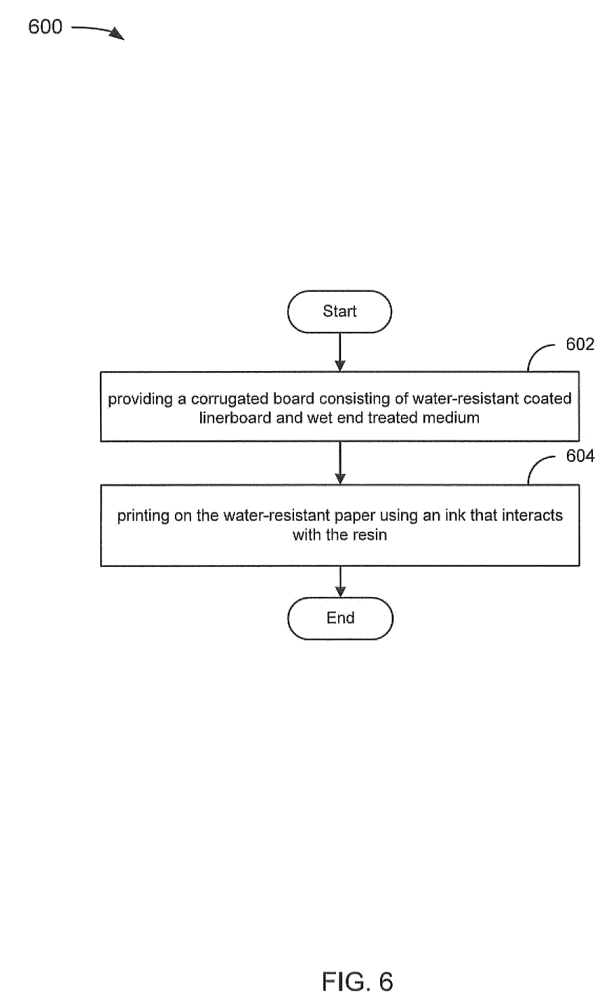

FIG. 6 depicts a flowchart 600 of a method for creating a waterproofed environmentally friendly paper container. The method is organized as a sequence of modules in the flowchart 600. However, it should be understood that these and modules associated with other methods described herein may be reordered for parallel execution or into different sequences of modules.

In the example of FIG. 6, the flowchart 600 starts at module 602 with providing a corrugated board consisting of water-resistant coated linerboard and a wet end treated medium. The resin may be a resin as discussed in reference to FIG. 1.

In the example of FIG. 6, the flowchart 600 continues to module 604 with printing on the water-resistant paper using a low impact ink that interacts with the resin. The ink may be ink as discussed in reference to FIG. 1, module 106. Having created a water proofed environmentally friendly paper container, the flowchart terminates.

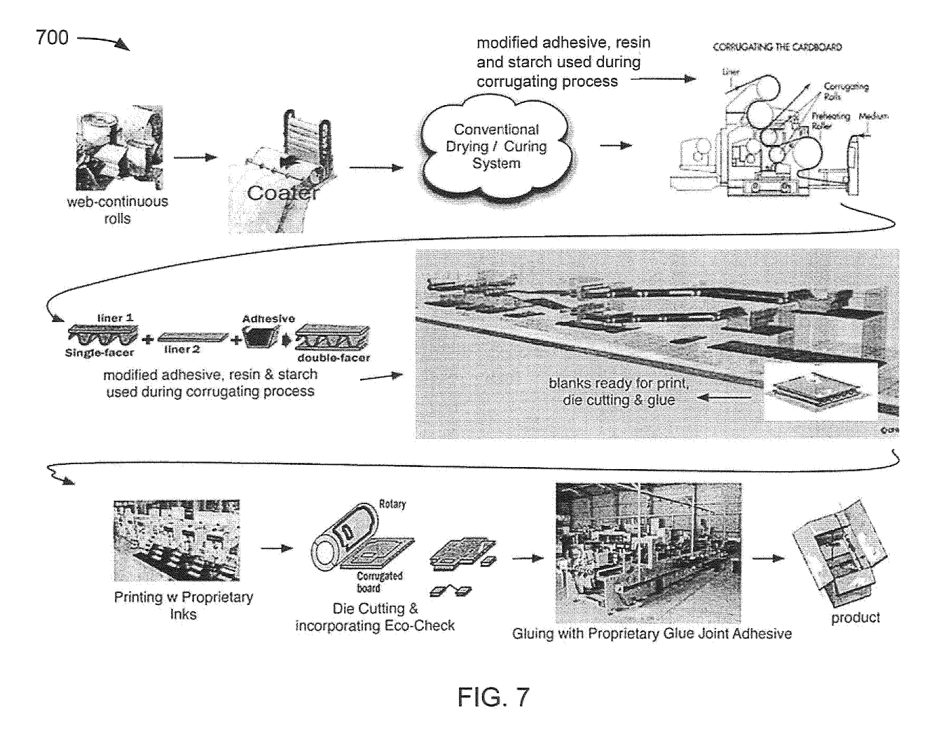

FIG. 7 depicts a diagram of an example of a process for creating a container. Specific process steps are indicated for purposes of example only. Steps may be reordered as is necessary for a particular application or convenient at the time.

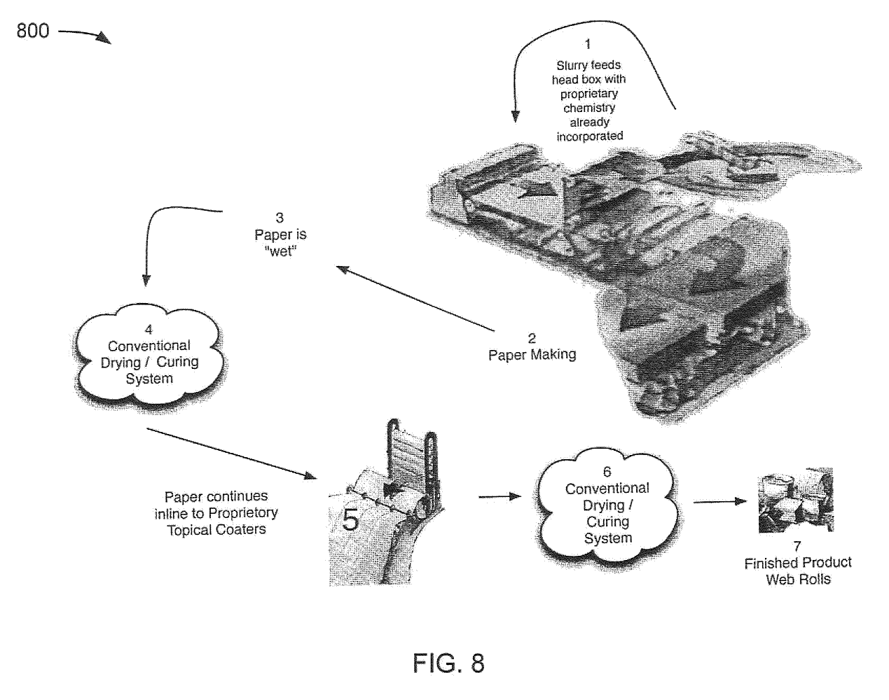

FIG. 8 depicts a diagram of an example of a process for creating paper. Specific process steps are indicated for purposes of example only. Steps may be reordered as is necessary for a particular application or convenient at the time.

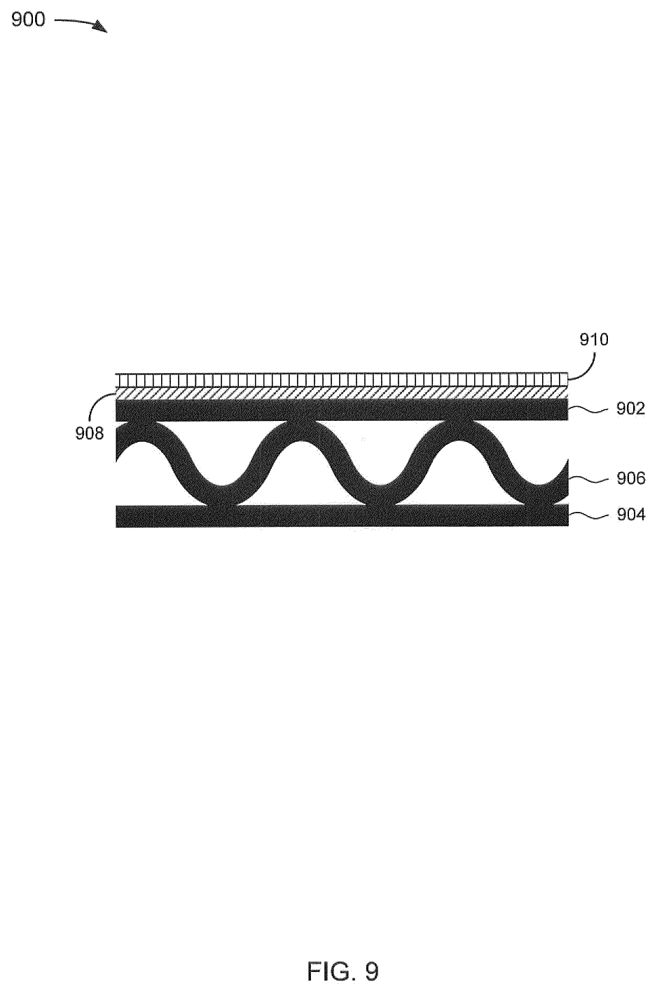

FIG. 9 depicts a diagram of an example of a cross section of a waterproof corrugated board. FIG. 9 includes first linerboard 902, second linerboard 904, fluted medium 906, basecoat 908, and topcoat 910.

In the example of FIG. 9, the first linerboard 902 may be coated with a basecoat 908 and topcoat 910 as described previously, where base basecoat 908 and topcoat 910 are resins. Alternatively, the first linerboard 902 may be coated with only one coating or with more than two coatings.

The first linerboard 902, the second linerboard 904, and the medium 906 may be formed into a corrugated board as discussed in reference to FIG. 1. The second linerboard 904 may also be coated. In a non-limiting example, a resin is introduced during wet-end treatment of the paper used to produce medium 906 to provide non-wicking characteristics.

It will be appreciated to those skilled in the art that the preceding examples are not limiting in scope. It is intended that all permutations, enhancements, equivalents, and improvements thereto that are apparent to those skilled in the art upon a reading of the specification and a study of the drawings are included within the true spirit and scope of these teachings. It is therefore intended that the following appended claims include all such modifications, permutations, and equivalents as fall within the true spirit and scope of these teachings.

What is claimed is:

1. A method for producing waterproof paper, the method comprising:
providing a web-continuous roll of paper;
coating the web-continuous roll of paper with a first resin;
drying the web-continuous roll of paper.

2. The method of claim 1, wherein the web-continuous roll of paper is coated with a second resin prior to the step of coating the web-continuous roll of paper with the first resin.

3. The method of claim 2, wherein the second resin is cured prior to the step of coating the web-continuous roll of paper with the first resin.

4. The method of claim 2, wherein the first resin is a water-based polymer resin, such as NVS 250.

5. The method of claim 2, wherein the second resin is a formulated pigment/binder basecoat, such as NVS 500.

6. The method of claim 1, wherein said waterproof paper is repulpable.

7. A method for producing a paper having non-wicking characteristics, the method comprising:
introducing a water-based polymer at the wet-end during production of the paper.

8. The method of claim 7, wherein the water-based polymer is NVS 300WE.

9. A method for producing a waterproof corrugated board, the method comprising:
providing one or more paper-boards, wherein at least one of said paper-boards is coated with a waterproof resin;
forming the one or more paper-boards into a corrugated board using water resistant adhesive;
wherein the corrugated board includes a medium and at least one linerboard.

10. The method of claim 9 wherein the medium is rendered non-wicking.

11. A method for producing a waterproof container, the method comprising:
providing one or more paper-boards, wherein at least one of said paper-boards is coated with a waterproof resin;
forming the one or more paper-boards into a corrugated board using water resistant adhesive;
cutting the corrugated board into a container blank;
forming said container blank into a container.

12. The method of claim 11, wherein the step of forming said container blank into the container is achieved using a water-resistant glue.

13. The method of claim 11 wherein the water resistant adhesive is at 140-150 degrees Fahrenheit during the step of forming the one or more paper-boards into a corrugated board.

14. A method for producing a waterproof corrugated form, the method comprising:
providing a fluted paper-board;
providing a first flat paper-board;
wherein the fluted paper-board is non-wicking and the first flat paper-board is coated with one or more coatings of a waterproof resin;
forming a corrugated board by adhering the fluted paper-board and the first flat paper-board together using a water resistant adhesive;
cutting the corrugated board into a blank;
forming said blank into a form using a water-resistant glue.

15. The method of claim 14, wherein the first flat paper-board and a second flat paper-board are adhered together using a water resistant adhesive.

16. The method of claim 15, wherein the second flat paper-board is coated with one or more coatings of the waterproof resin.

17. The method of claim 15, wherein the waterproof resin is applied on the side of the corrugated board that is configured to be exposed to water or moist products.

18. A system for making a waterproof container comprising:
a coater, wherein, in operation, the coater applies resin to paper inhibiting water from permeating the paper;
a dryer, wherein, in operation, the dryer dries resin on paper;
a corrugation device; wherein, in operation, the corrugation device forms resin coated paper into corrugated paper-board;
a cutter; wherein, in operation, the cutter cuts paper board into a container shape.

19. The system of claim 18 further comprising a printer, wherein, in operation, the printer applies resin compatible ink to resin coated paper-board.

20. The system of claim 18, wherein the dryer is an IR dryer, an air dryer, or a combination of both.

21. The system of claim 18, wherein the dryer is configured to provide a temperature of 205 degrees Fahrenheit at the surface of the paper.

22. The system of claim 18, wherein the cutter is a die cutter, a printer-slotter, or a flexo folder-gluer.

23. A waterproof container comprising:
at least one piece of paper-board coated with a waterproof resin, the paper-board cut to be erected in the form of a base and walls;

24. The waterproof container of claim 23, wherein the container is formed using water-resistant glue on the paper-board.

25. The waterproof container of claim 23, further comprising:
a second piece of paper-board coated with the waterproof resin having cuts that when erected form a lid for the container.

26. The waterproof container of claim 23 wherein the container is a cooler, a poultry box, a fish box, a produce tray, a food processor tray, a floral tray, or a collapsible crate.

27. A waterproof corrugated container comprising:
at least one piece of corrugated board coated with a waterproof resin, the paper-board cut to be erected in the form of a base and walls;
wherein the corrugated board is formed using an water resistant adhesive.

28. A system for making a waterproof container comprising:
means for applying a resin to paper;
means for curing the resin on said paper;
means for corrugating the paper coated with said resin;
means for forming corrugated board;
means for cutting the corrugated board into a container blank;
means for forming a container from the container blank.

29. The system of claim 27 further comprising means for applying resin compatible ink to resin coated paper-board.
